(19) United States
(12) Patent Application Publication
(10) Pub. No.: US 2013/0223696 A1
(43) Pub. Date: Aug. 29, 2013

(54) SYSTEM AND METHOD FOR PROVIDING SECURE ACCESS TO AN ELECTRONIC DEVICE USING FACIAL BIOMETRIC IDENTIFICATION AND SCREEN GESTURE

(71) Applicant: SENSIBLE VISION, INC., (US)

(72) Inventors: Cyrus Azar, Spokane Valley, WA (US); George Brostoff, Covert, MI (US)

(73) Assignee: SENSIBLE VISION, INC., Covert, MI (US)

(21) Appl. No.: 13/737,501

(22) Filed: Jan. 9, 2013

Related U.S. Application Data
(60) Provisional application No. 61/584,492, filed on Jan. 9, 2012.

(51) Int. Cl. G06K 9/00

(52) U.S. Cl. CPC G06K 9/00221
USPC 382/118

(57) ABSTRACT

A system and method for providing secure authorization to a device (800) that includes the steps of combining two or more security factors for authentication (805,807) operating at about the same time where at least one of the factors is a “tolerant” factor. By combining two factors analyzed at about the same time (805,807), the tolerance match required by the tolerant factor(s) can be reduced without reducing the overall security accuracy.

### PRIORITY CLAIM TO RELATED APPLICATION

This patent application claims the benefit of, and priority under 35 USC §119(e) to Provisional Patent Application Ser. No. 61/584,492 filed Jan. 9, 2012, the disclosure of which is incorporated herein by reference.

### CROSS-REFERENCE TO RELATED APPLICATIONS

This application is cross-referenced to U.S. Ser. No. 61/692,999 entitled System and Method for Disabling Secure Access to an Electronic Device Using Detection of a Unique Motion filed Aug. 24, 2012, U.S. application Ser. No. 13/550,104 entitled System and Method for Providing Secure Access to an Electronic Device Using both a Screen Gesture and Facial Biometrics filed Jul. 16, 2012, and U.S. application Ser. No. 11/154,879 entitled System and Method for Providing Secure Access to an Electronic Device Using Facial Biometrics filed Jun. 16, 2005, which are all commonly assigned to Sensible Vision, Inc. and are all incorporated by reference in their entities.

### FIELD OF THE INVENTION

This invention relates in general to electronic security and more particularly to a method using both a screen gesture and facial biometrics for authenticating the user of an electronic device.

### BACKGROUND OF THE INVENTION

Many electronic devices such as personal computers, mobile devices including mobile phones and personal digital assistants (PDAs) use some form of authentication, typically a password that must be input into the device to gain access. The password is most often typed onto a keyboard or other interface which then allows the user to gain partial or full access to the utility of the device and/or network. A problem associated with using passwords is that they are time consuming and inconvenient for the user to enter. Users often use informal passwords or share their password with others which works to compromise system security. These practices negate the password's value and make it difficult to have an accurate auditing of access. Moreover, passwords are expensive to administer when forgotten, shared with others or misplaced. Although the use of other types of security access systems such as voice recognition, fingerprint recognition or iris scans have been implemented, these types of systems require a different procedure to access and use the device. These techniques also require a specific and time-consuming enrollment process in order to be operational.

Thus, “identity management” has always presented challenges. From the beginning, individuals have been associated with usernames and passwords in order to gain access into computer systems, creating the significant challenge of authentication—validating that the individual is “truly who they say they are”. This has traditionally meant remembering and entering unique user names and passwords for the computer, secured applications and a multitude of websites. For systems requiring additional security control such as online banking, individuals have been required to use “two factor authentications”. This requires multiple types of identification such as a password plus a PIN or token. As users have grown more efficient through the use of multiple electronic devices and services such as smartphones, email, online banking, social networking, keeping track of multiple passwords and constantly entering them has simply become inconvenient at best and unmanageable for many. Almost daily, the news shares with us how cybercrime has heightened the challenge . . . forcing the use of longer, more complex passwords which must be changed frequently or risk losing critical information, privacy, reputation and money. Added complexity discourages the use of and compliance with strong security measures and policies. Frustrated users can themselves pose a security risk.

Biometric authentication using facial recognition is often used to gain access to electronic devices. U.S. Pat. No. 6,853,739 to Kyle and U.S. Pa. No. 6,724,919 to Akiyama et al., which are both herein incorporated by reference, disclose examples of identity verification systems wherein a database is employed to compare facial features of a user to those in the pre-established database. Once a comparison is made, then authentication is verified and access is granted to the system. The disadvantage of this type of system is the requirement of a separate and specific enrollment procedure by the user to create the database. As with this type of facial recognition system and others in the prior art, the database must be populated before being used; otherwise, the system will not operate. This puts an unnecessary burden on the system operator, requiring detailed education on the steps to populate the database before the system may become operational. Additionally, this type of security system does not permit the automatic updating of the database to accommodate changes in head position, user features (such as different glasses), a change in the camera's operational characteristics, lighting and other environmental factors. This can limit the speed, accuracy, and even the success of database matching (recognition). Also, these prior art facial recognition and other biometric systems operate only at the instant of authentication.

Still other techniques use a gesture associated with the device's display. This type of recognition technique involves the user touching the device's touch screen and movements that are recognized by the device. These movements can be linked to device functionality such as operation of certain appliances or allowing access to the device. A gesture is the movement of the user's finger on the touch screen, in a pattern or shape that they have identified or selected. Certain factors rely on exact matching while other factors due to their nature of their design use some level of matching tolerance also known as tolerant factors to determine acceptance of the gesture or credential. Examples of exact factor include a user's full password, smartcard or the code from a hardware security token. These factors must always precisely match the previously stored credentials. A tolerant factor would include all forms of biometrics (face, voice and finger), pattern and gesture entry where some defined deviation/tolerance from an exact match to the stored credentials is permitted (and is required to actually function). Even a password can become a tolerant factor if less than the full length of the password is accepted under certain circumstances.

Another example of a security system using biometrics to supplement password entry is U.S. Pat. No. 7,161,468 to Hwang et al. Described therein is a user authentication apparatus that authenticates a user based on a password input by the user and the user's biometrics information. The user authentication apparatus includes a password input unit which determines whether a password has been input; a storage unit which stores a registered password and registered biometrics; a threshold value setting unit which sets a first threshold value if the input password matches with a registered password and sets a second threshold value if the input password does not match with the registered password; and a biometrics unit which obtains biometrics information from the outside, determines how much the obtained biometrics information matches with registered biometrics information, and authenticates a user if the extent to which the obtained biometrics information matches with registered biometrics information is larger than the first or second threshold value. As an example of how such a system could be adapted within the scope of the present invention, the biometrics input could be supplemented with a hidden action to either fully authenticate the user or convey a secondary password and associated actions, such as account restrictions, feigned access, or issuance of alerts, following previously configured rules.

Finally, U.S. Patent Publication No. 2009/0160609 to Lin describes a method of unlocking a locked computing device where the user's touch is used as a request to unlock a device while biometric information can be used with this process. Although the user may use a touch screen for a request to unlock the device, Lin does not use a combination of both a screen gesture and biometric information to authenticate the user.

Thus, although the use of gestures and biometric security systems are separately available in the art, there presently is no system that works to combine these techniques for providing robust security while also providing a user with flexible access to an electronic device.

### BRIEF DESCRIPTION OF THE DRAWINGS

FIG. 1 is a block diagram showing the topology of the system and method of the invention wherein a camera is used to provide user system authentication

FIG. 2 is a flow chart diagram illustrating an overview of the method using facial biometrics.

FIG. 3 is a flow chart diagram illustrating a continuous authentication routine used in accordance with an embodiment of the invention.

FIG. 4 is a flow chart diagram illustrating a back-timing process used with the automatic database in accordance with an embodiment of the invention.

FIG. 5 is a flow chart diagram illustrating facial feature tracking and a delayed lock subroutine as used in accordance with an embodiment of the invention.

FIG. 6 is a flow chart diagram illustrating an alternative embodiment to the biometric authentication and delayed lock routine shown in FIG. 5 as used in accordance with the invention.

FIG. 7 is a block diagram showing the topology of the system and method of the invention wherein a screen gesture and camera are used to provide user system authentication in accordance with an alternative embodiment of the invention.

FIG. 8 is a flow chart diagram illustrating yet another alternative embodiment for providing authentication of an electronic device using both a screen gesture and facial biometrics.

FIGS. 9A and 9B illustrate a touch screen which exhibits the features of dynamic gesture placement.

FIG. 10 is a flow chart diagram illustrating the process of using both facial recognition and other factors for authentication a user for access to an electronic device.

### DETAILED DESCRIPTION OF THE PREFERRED EMBODIMENTS

The invention closes a fundamental security hole that exists in many forms of existing security authentication for all types of electronic devices that require secure access. Existing security methods only confirm the user at the moment, the user enters his or her password, scans his or her fingerprint, or iris, etc. The system has no ability to discern whether the current user is the same individual who authenticated even a few milliseconds earlier. This leaves the device completely unsecured and vulnerable until it is logged off or locked. It only takes a few moments for persons having malicious intent to steal and/or delete data from a device from which the user has already logged in. The existing solution is to require the user to manually lock/logoff, or create user inactivity timers to lock or logoff a user.

In addition, most information technology (IT) organizations resist change because they prefer not to risk changes that would affect their existing hardware/software systems. Also, they prefer not to expend the support costs necessary for implementing a solution. Support costs for training users and answering help desk questions can be significant factors. The present invention automates the database creation in a way that is transparent to the end user. The invention requires little training with minimal “help desk” costs. The invention utilizes an auto-enrollment feature that permits the device to automatically update a database to constantly improve the quality of the user recognition. In contrast, current biometric products require a special set of steps to establish and update the database. In some cases, these steps can be performed by the user only after a learning orientation. In many cases, an IT administrator must work with the user to actually train the database before it can be used in the system.

Security compliance is also a major problem often requiring users to manually lock or logoff their computers when stepping away from them. This process is time consuming, cumbersome and is secondary to the user's purpose in using the computer. Moreover, locking or logging off requires the user to enter a password when the user returns to the device which is a major inconvenience. Unless rigorously enforced, users will typically ignore the proper security procedures. Short of direct observation, there is essentially no way for a system administrator to confirm that users are properly following a prescribed security policy.

One impractical solution has often involved the use of a timer. The timer works by locking the device when there is no peripheral activity within a predetermined time period. As will be recognized by those skilled in the art, the peripherals may include, but are not limited to, a mouse, keyboard or touch screen. If a timer is set to a short enough duration to reasonably close a security hole when the user steps away, the device will lock when the user is reviewing data on the screen. The user is then constantly inputting his or her credentials each time the system locks or logs the user off. This causes frustration for the user and greatly reduces productivity. As a result, typical inactivity times are at least 2-5 minutes, which provides a huge window of vulnerability. In addition, inactivity timers are ineffective. All an unauthorized user must do is access the system within the timer period. After that, the unauthorized user can continue working indefinitely.

The system and method of the present invention directly address these compliance issues by automating the process, thus ensuring complete compliance. Since the process is automated and transparent to the operator, user acceptance is very high. The users find the system is more convenient to use than before the installation of the present invention. Additionally, system audit logs showing persons who accessed the device are now accurate because of this continuous authentication security process. The invention operates by instantly locking/logging off when the user is out of view of the device and then unlocking as soon as the user reappears in front of the computer.

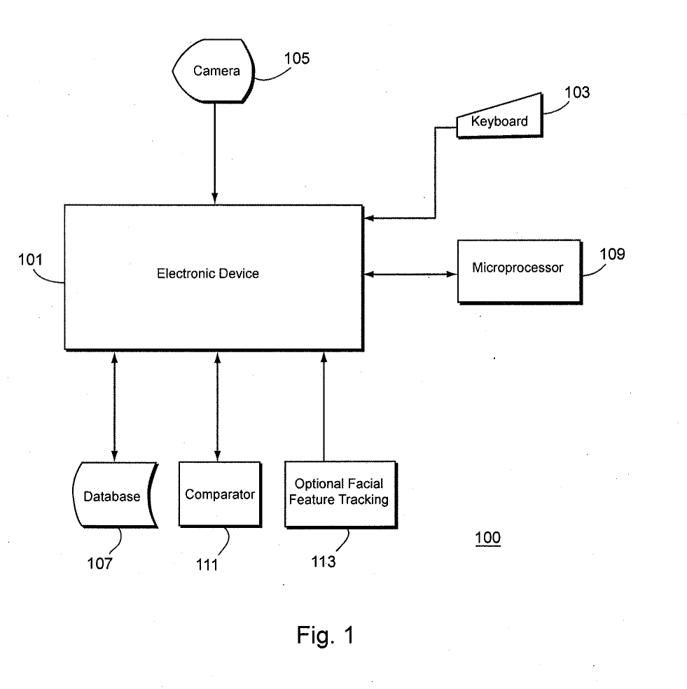

Referring now to FIG. 1, the system 100 as used in accordance with the present invention includes an electronic device 101 including, but not limited to, a personal computer, mobile telephone, alpha numeric paging device, personal digital assistant (PDA), electronic gaming device or the like which require some type of authentication to gain access to the utility of the device 101. A camera 105 may also be used to add an additional level of security to the device where the camera is used in connection with the device 101 to populate an internal database 107 with a plurality of image vectors. The camera provides substantially real-time images and typically runs at a rate of approximately 5-10 frames per second for continuously supplying digital image data to the electronic device 101. The camera is used in connection with an optional facial feature tracking software typically used within the device that works to track the movement of the user's face while in a position in front of the camera. Thus, as the user moves his head back and forth or side to side while using the device, the software used in connection with the camera will track this facial movement to allow continuous authentication while using low CPU and device resources 113.

Those skilled in the art will recognize that the camera 105 may be integrated into the electronic device 101 or it may stand alone as an accessory or peripheral, sending image data to the electronic device through a wired or wireless connection. As described in connection with the preferred method of the invention, a microprocessor 109 is then used with a comparator 111 for making a determination whether images continuously supplied by the camera 105 are human facial images. If a human facial image is detected, it is determined whether this image matches any of those stored in the database 107 from previous user sessions. Each vector represents a numerical representation of a digital image sent from the camera 105 to the electronic device 101. As will be discussed herein, the electronic device 101 makes a comparison between a vector established in the database 107 with a current vector provided by the camera 105. When a match is affirmatively established and the user is authenticated, the system 100 may be configured to allow a user either full or limited access to the electronic device 101.

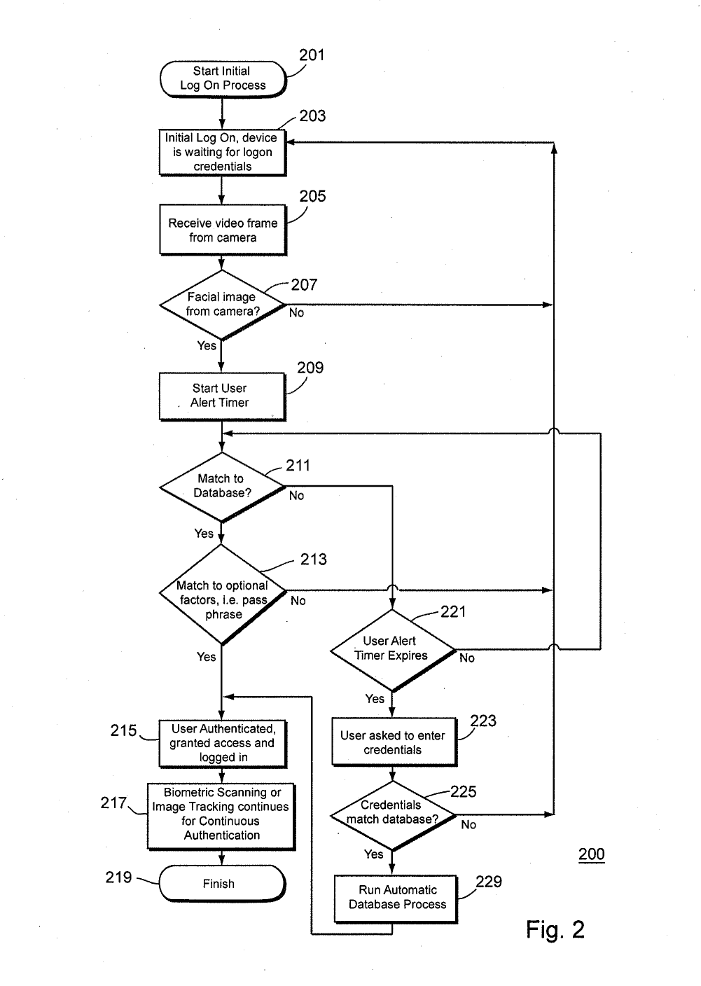

FIG. 2 is a flow chart diagram illustrating an overview of the facial biometric method 100 of an embodiment of the present invention. Although this method is depicted as a sequence in FIG. 2, it will be evident to those skilled in the art that other iterations and definitions are possible without departing from the spirit and scope of the present method. These methods may include, but are not limited to, two-dimensional (2D), three-dimensional (3D), infrared (IR) and/or other facial recognition techniques. In the method for the facial biometric overview 200, the initial startup process for logging on to the device is initiated 201, and the device displays a screen 203 allowing the user to supply his or her login password or other authentication credentials. A video frame is received 205 from the camera associated with the device whereby the device then determines 207 whether the image data received from the camera is a facial image using face detection. If it is not a facial image, the device then continues to wait 203 for the user's login credentials.

However, if the image data is a facial image, a user alert timer is started 209. The user alert timer is used to establish some predetermined time within which the user should be authenticated before a message is displayed to the user to request the user to manually input his or her credentials. The expiration of the user alert timer has no effect on authentication other than to recommend to the user to login manually since the authentication process has exceeded an expected duration and the system would benefit from a database update. Thus, the camera frames continue to be evaluated even if the user is requested to enter a password. The system may be able to identify users as they are entering their credentials, speeding their access. So long as the user remains in front of the device, the system and method of the invention attempts to perform a database match. Even after authentication has occurred, each camera frame is evaluated utilizing this continuous authentication feature.

After the image from the camera is converted to an image vector, the device then determines 211 if the vector has any match to one already established in the database. If no match occurs and the user alert timer has not expired 221, then the device continues to process new incoming image vectors with those in the database to determine whether a match occurs. If the user alert timer has expired, the user is then requested 223 for his log-in credentials which may be input using a keyboard onto which the user can manually input a password or other credentials or, alternatively, another type of interface such as other biometric methods. Concurrently, the device continues to scan new incoming images/vectors for a match to the database 211. If at any time there is a match to the database 211, the system will proceed to match to optional factors 213. If the credentials input by the user do not match those stored in the database, the process starts again whereby the device waits for initial login credentials from the user 203 and scanning for vectors continues.

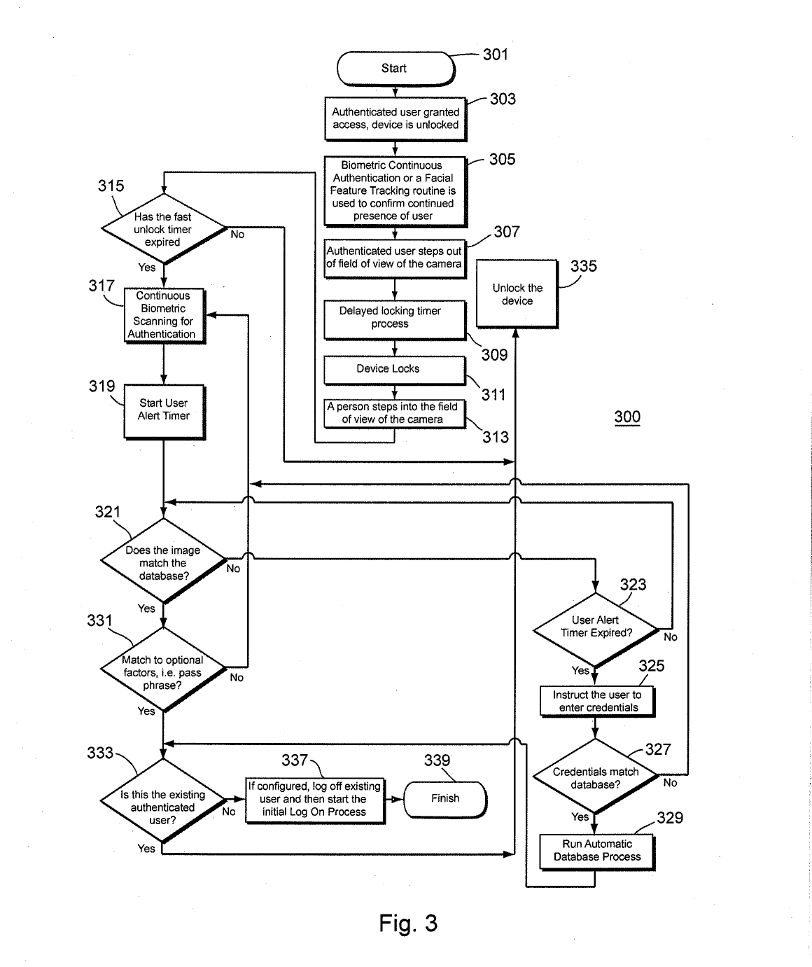

However, if the credentials do match those in the database and match the optional factors authentication factors 213, then the automatic database process is initiated which will be discussed with regard to FIG. 3. In the event that a match does occur between the current vector received from the camera and one stored in the database before the user alert timer 221 expires, then the user may be prompted for one or more additional authentication factors such as a pass phrase or a second password that provides an optional additional factor for authentication. If the user fails to provide this pass phrase or if the pass phrase does not match that in the database, the system returns to the start, the user alert timer is reset and the initial logon screen 203 is displayed.

Once the user is authenticated, the user is then granted access 215 and logged into the device for full or limited use of its features. An inventive aspect of the present invention, as compared to the prior art, is that the user 217 is continuously scanned and authenticated once the user has gained access. Those skilled in the art will recognize that this continuous authentication process enables the user to step away from the device, allowing the viewing screen to be disabled so images present on the screen or monitor are no longer able to be viewed and data entry locked. Thus, text, images or other data presently displayed on the device may be easily secured when the user moves from the camera's field of view. Once the user again steps back into the camera's view, the method of the present invention provides for re-authentication of that user. Once re-authentication is established, the display and data entry are unlocked, allowing instant access to the device in the same state as when the user stepped from view.

In typical use, while a personal computer is secured using this method, the application software running on the device is unaffected and continues to run on the device, although with no display. However, the method of the invention allows the user to select to what extent the device will be affected when the device becomes locked or unlocked. Thus, the user may determine to have the device: 1) locked; 2) unlocked; 3) logon on; or 4) logged off, using this method. The “locking” of the device provides a secure desktop without disconnecting the user from a document or email server and without shutting down any application software running on the device. The display, keyboard and/or mouse on the device may be disabled while the user is not present within the camera's view. Once the user steps back into the field of view, the method provides for re-authentication. Once this security is reestablished, the device's display is again enabled for use. Hence, this process provides a simplified means of maintaining security of a personal computer or other device while the user is situated outside the camera's field of view. Since facial biometrics are used and the user is continuously authenticated, the user can be assured that data displayed on the device and access to the network will be secure when the user steps away from a work station for a moment or longer periods of time.

FIG. 3 is a flow chart diagram illustrating the continuous authentication routine as briefly described in FIG. 2. The continuous authentication process is a key feature of the invention since it allows the user to be easily re-authenticated after stepping from the camera's field of view. The continuous authentication process 300 begins 301 when an authenticated user is granted access and the device is unlocked 303. A biometric re-authentication or facial feature tracking routine is used to confirm 305 that the user remains present in the camera's field of view. Re-authentication of the user's face allows the highest degree of security while keeping the system unlocked. Conversely, Facial

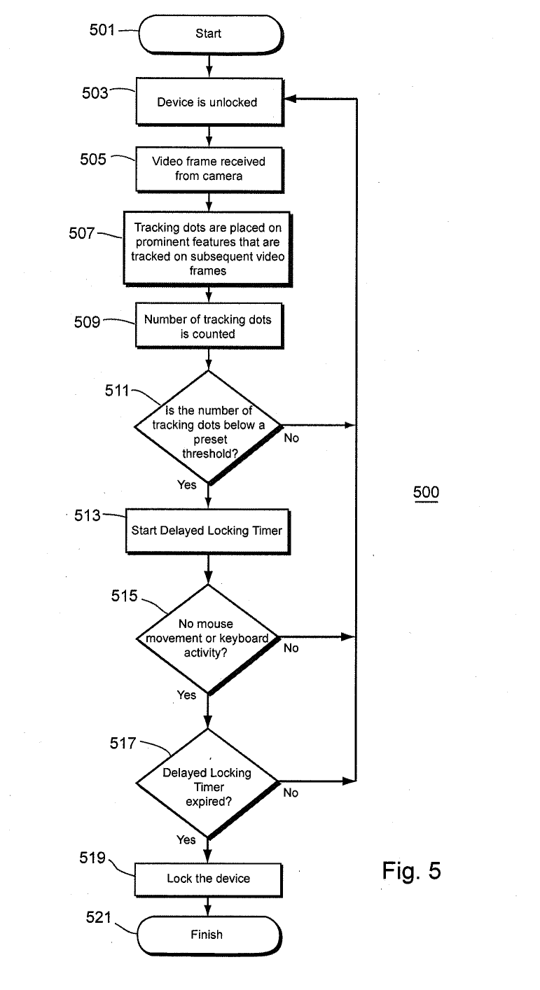

Feature tracking allows high security with low CPU resources by tracking the authenticated user's features. Facial Feature Tracking and continuous authentication is discussed herein with regard to FIG. 5.

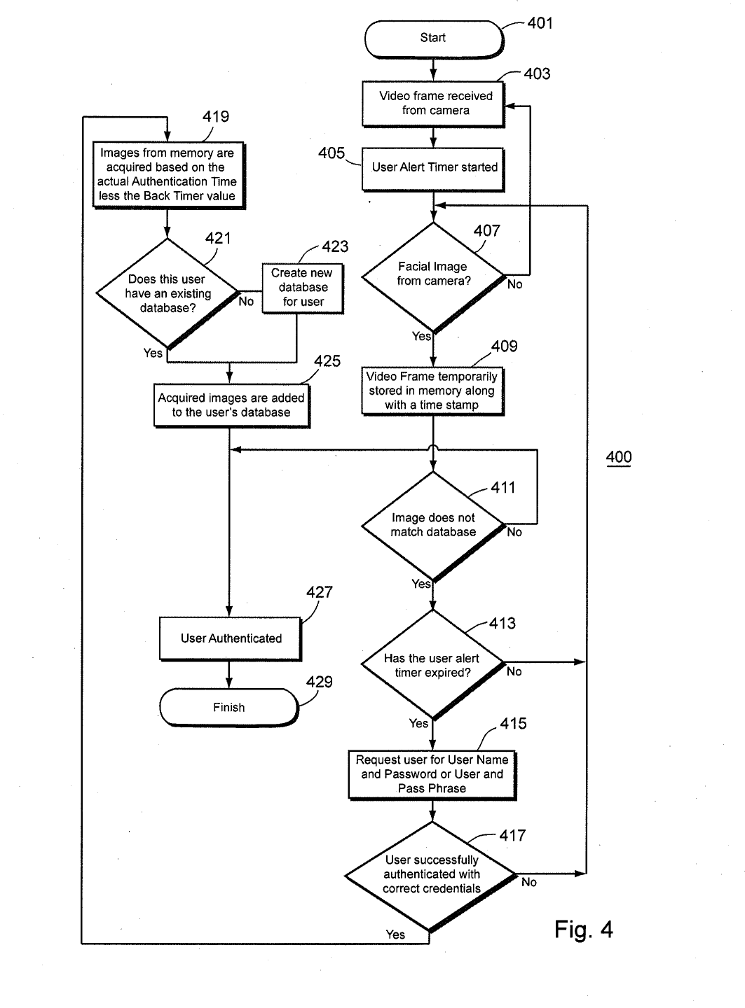

If an authenticated user steps out of the field of view of the camera 307, an optional delayed locking timer process is initiated 309. The delayed locking timer process will be more fully described with regard to FIG. 5. After this process is complete, the device is locked 311. If a user does step into the field of view of the camera 313, a determination is made whether the optional fast unlock timer has expired 315. If used, the fast unlock timer is typically brief, usually 1-10 seconds. If the fast unlock timer has not expired, the device is unlocked 335 with the presence of any face rather than the recognition of a specific face. If the fast lock timer has expired, the device resumes 317 continuous biometric scanning for authentication. The user alert timer is restarted 319, and it is determined whether the image from the camera matches 321 a vector stored in the database. If the camera image does not match any stored image then it is determined whether the user alert timer has expired 323. If not, the process continues where the image is matched 321 against those in the database. If the user alert timer has expired, biometric scanning and database matching continues and the current user is requested 325 for his or her authentication credentials. If there is a match, the automatic database process is started 329 as more fully described in FIG. 4. If a database match is made before the user enters his or her credentials but the user alert timer has expired, the automatic database process 329 is executed. At the completion of the automatic database process, the user will be considered authenticated. The system will either unlock the device 335, or optionally logoff an existing user 337 who had locked the computer. The system will then automatically log on the new user to the user's account without any additional authentication.

If an image does initially match one that is in the database 321, the user may optionally be prompted 331 for additional authentication factors such as a pass phrase or other type of password. If there is no match for the additional authentication factors, the ongoing biometric scanning is continued 317. If there is a match, a determination 333 is made whether this is the existing authenticated user who may have just momentarily stepped from the field of view. If it is the existing authenticated user, the device is unlocked 335. If it is not the existing user, the device may be configured to log off 337 the existing user and start the initial log-in process 301 at which point the continuous authentication routine is completed 339.

FIG. 4 is a flow chart diagram illustrating the process for populating the database together with a back timer process 400 that can be used to improve the quality of the vectors in the database. The automatic database is a process by which the system database will be created or updated while a user uses the system and enters a password, or a database match occurred after the user alert timer expired. Although a password may initially be required, an objective of the automatic database is to permit the data to be populated through actual use rather than a specific enrollment procedure, whereby a user can eventually stop using password authentication and the method of the invention can be employed to authenticate using facial biometric data. By updating the database whenever it has taken too long a period of time for the database matching, the quality of the database is improved and the amount of time for subsequent database matches decreases. This also accommodates the various physical changes to a user's face over time, including ageing, changes in glasses, color of the skin (tanning), the position of the user's head relative to the camera, changing camera characteristic, and various environmental conditions including lighting. The purpose of the back timer process is to update the database with one or more images from a time previous to the actual recognition or authentication event. This permits the system to acquire higher quality images that closely match the head position of the user when the user is first accessing the device.

The automatic database and back timer process starts 401 when a video frame is received 403 from the camera. The user alert timer is started 405 and a determination is made 407 whether the image is a facial image. If it is not a facial image, the routine returns to receiving a video 403. Once a facial image is detected, the video frame is temporarily stored 409 in memory along with a time stamp. The time stamp denotes the actual time the facial image was processed by the camera. A comparison is made 411 to determine whether the image matches another image vector in the database. If a match occurs, then the user is authenticated 427. If no match occurs, a determination is made 413 whether the user alert timer has expired. If the user alert timer has not expired, the image is then reviewed 407 to determine whether it is a facial image. If the user alert timer has expired, the user is requested 415 for the user's name and password, pass phrase or the like. If the user is not authenticated with the correct credentials 417, the image is again reviewed 407 to determine whether it is a facial image. If the user is authenticated, then images from memory are acquired 419 based on the actual authentication time less the back timer value. Since video frames are still received 403 and database matching 411 continues while the user is requested to enter his or her credentials, the system may make a database match and proceed to User Authenticated 407 even as the user is entering his or her credentials. It is next determined 421 whether the user has preexisting images in the database. If the user does not have a preexisting image in the database, a new database is created 423 for that user. Subsequently, once the new database is created or preexisting images are available, the acquired images are added 425 to the user's database. The user is then authenticated 427 and the process is completed 429.

FIG. 5 is a flow chart diagram illustrating a continuous facial feature tracking and delayed lock process 500 as used for the continuous authentication embodiment of the invention. The benefit of facial feature tracking as a method of continuous authentication is a substantially low central processing unit (CPU) load and high tolerance for the position of the user's face relative to the camera. Since the system can lock or start a log off in a very short time period, the delayed locking timer permits the user to set how quickly the system locks to match the user's usage requirements. This process operates immediately after initial authentication 215 until the device is locked or logged off. If this condition exists, the system will remain unlocked if there is tracking of the user's face or any mouse or keyboard activity. This can be desirable as the locking/logoff action may occur too quickly. Once the mouse or keyboard activity is no longer detected, the method of the invention provides an optional predetermined time period before the device will be locked. If the user's face returns to the field of view or if keyboard/mouse activity is restarted before an inactivity timer expires, then the device will not lock and the timer is reset.

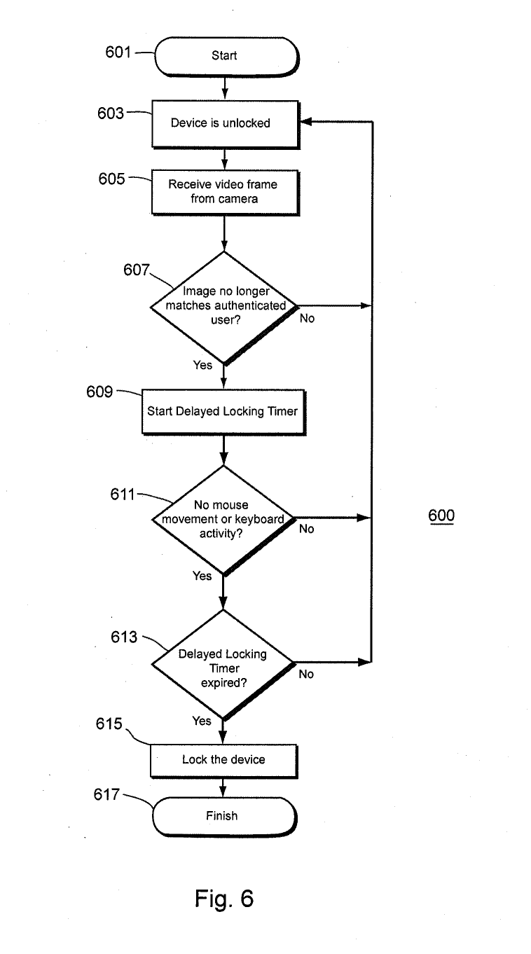

More specifically, the process starts 501 when an authenticated user is granted access to the device which is unlocked 503. A video frame is received from the camera 505 and one or more tracking dots are placed 507 on the prominent features of the user's face. The number of tracking dots are then counted 509 and a determination is made 511 of how many tracking dots are present. If tracking dots meet a minimum threshold, then the process begins again, where the user has been granted access 503 and the device remains unlocked. If the number of tracking dots is below the minimum threshold, the delay locking timer is started 513. The process for using the delayed locking timer is more fully described with regard to FIG. 6. It is next determined 515 whether there is any mouse, keyboard or other peripheral activity such as activity on a touch screen. If there is no activity, the process begins again 503 with the authenticated user having access to an unlocked device. If there is activity on the mouse or keyboard, it is determined 517 whether the delay locking timer 519 has expired. If the delayed locking timer has not expired, the process is restarted 503. If the locking timer has expired, the device is locked 529 and the process is completed 521.

FIG. 6 illustrates a Continuous Biometric Authentication & Delayed Locking flow chart diagram which is an alternative embodiment to the Continuous Facial Feature Tracking and Delayed Lock process 500 as shown in FIG. 5. Although the method described in FIG. 6 is very similar to the tracking feature described in FIG. 5, continuous biometric authentication provides theoretically better security because it is constantly reconfirming the user. In practice, the continuous facial feature tracking can lock the system so rapidly that it would be difficult for a new user to replace the existing user before the system locks. Matching database vectors for continuous biometric authentication is very CPU-intensive, and it requires a more consistent placement of the user's face in front of the camera. These two factors make continuous biometric authentication less desirable in many environments and devices. An alternative implementation would include a combination of both Continuous Biometric Authentication and Continuous Facial Feature Tracking where facial feature tracking is performed the majority of the time and Biometric Authentication is run at periodic intervals.

In FIG. 6, a continuous biometric authentication and the delayed lock process 600 are used. The process is started 601 when the user has been granted access 603 to an unlocked device. A video frame from the camera is received 605 and it is determined whether the image matches the authenticated user. If the images do not match, the process begins again with the user continuing access 603 to an unlocked device. If the image does not match that of an authenticated user, a delayed lock timer is started 609 and it is determined 611 whether there is any mouse or keyboard activity. If no activity is present and the delayed lock timer 613 has expired the device will lock or log off 615 and the routine will finish 617. If there is no activity 611 and the delayed locking timer has not expired 613, the device begins again 603. If there is activity 611 or the delayed locking timer 613 has not expired, the process begins again 603.

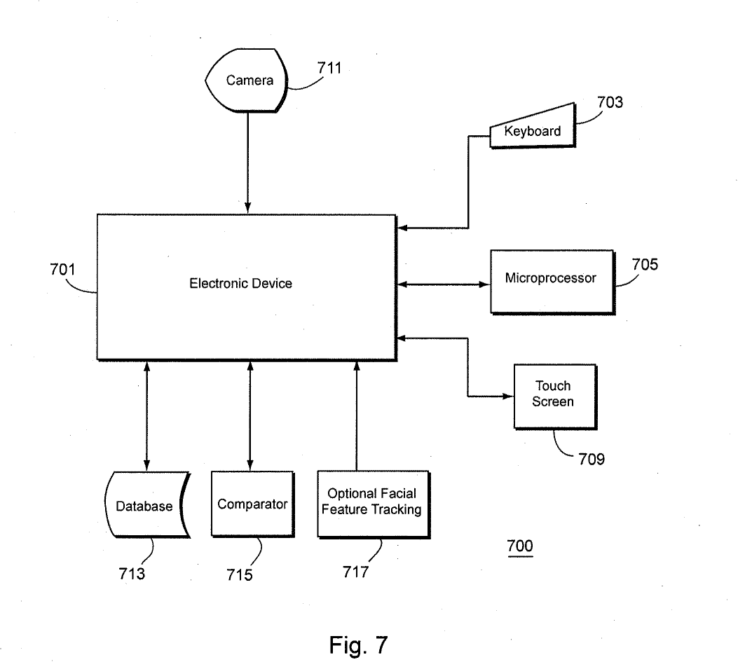

FIG. 7 is a block diagram showing the topology of the system and method of the invention wherein a screen pattern and/or gesture and camera are used to provide user system authentication in accordance with an alternative embodiment of the invention. Initially, those skilled in the art should recognize that a “tolerant” factor are those type inputs or factors that are tolerant since they can be accepted without having exacting precision to provide secure access to an electronic device. In other words, an exact match may not be necessary but instead only one that is similar in some predetermined manner. Accordingly, specific factors can be selected and/or adjusted so that an “exact” factor meaning their matching tolerance must be exactly and/or substantially precise in order to allow access to the device. The degree upon which the tolerant or exact factors will operate correctly are generally selected by the manufacturer of the software; however, it is the combination of these types of factors that allow the method to provide a great deal of security for the device while still providing easy use and access by the user.

The system 700 includes each of the components as described with regard to FIG. 1; however, this device also includes a touch screen 709 that is connected to and used within the electronic device 701. Although shown using a separate keyboard 703, those skilled in the art will recognize that the keyboard 703 can also be integrated with the touch screen 709 in software to form a virtual keyboard so that the keyboard 703 and touch screen 709 would act as one device. As noted herein, the touch screen 709 will operate in combination with the camera 711 whose inputs are controlled and interpreted by the microprocessor 705. This allows the user to input a gesture into the touch screen 709 that is used in combination with the camera 711 to provide user authentication for the device. These inputs are compared to data and other information stored in database 713. This data can be compared using a comparator 715 that provides a comparative type analysis for providing operational access to the electronic device 701. As described herein, an optical tracking feature 717 can also be used to insure the user of the device remains the same person with no gaps or breaches in security.

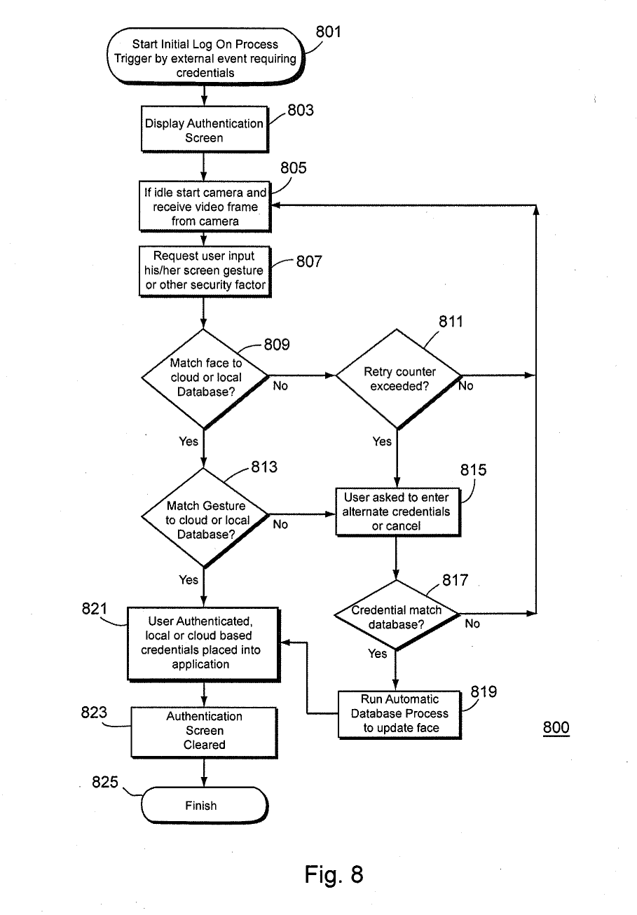

FIG. 8 is a flow chart diagram illustrating yet another alternative embodiment for providing user authentication of an electronic device using both a screen pattern/gesture and facial biometrics. The authentication process using both a screen gesture and facial biometrics 800 includes the steps of starting the initial “log-on” process 801 that triggers some external event requiring authentication credentials to be entered by the user. An authentication screen is then displayed 803 and at least one video frame is received by the camera 805 so that the user can then input a predetermined screen gesture or other security factor 807. While in practice it will seem to the user that one or more of the security factor(s) occurs before the other, those skilled in the art will further recognize that in the method of the invention, these need not occur at the same time or in specific order. In practice, due to the delay in activating the camera this step may occur first but is not required.

Thereafter, a determination is made to match the facial recognition frame received by the camera to a cloud or local data 809. Those skilled in the art will recognize that “cloud computing” means using multiple server computers via a digital network, as though they were one computer. Computer using cloud computing may be accessed via the Internet or the like. If some predetermined time period or some counter using number of tried or other data is exceeded 811, then the user is asked to enter alternate credentials or cancel the request 815. If the counter is not exceeded, then the camera will be used for supplying additional video frames 805. Once alternate credentials are entered, then a determination is made if the credentials match those stored in a database 817. If the credentials match, then an automatic database process is performed to update the images and/or other data stored in the database 819. If the credentials do not match, then the camera can be used for supplying additional video frames for authentication 805.

When the gesture does not match to the cloud or local database 813, then the user is again asked to enter alterative credentials or cancel the request 815. If the new credentials do not match, then the process starts again with at least one new frame from the camera 805; however, if the new credentials do match then an update is performed on the automatic database to update the facial biometrics 819. However, if the gestures do match 813, then the user is authenticated and the local cloud based credentials can be placed into a specific application for granting access and/or use 821. Any updated biometric facial data 819 will be used in this authentication process 821. Thereafter, the authentication screen is cleared 823 and the process ends 825.

In typical use, a user on a Smartphone or any device requiring authentication, accesses the device or application that requires authentication. This authentication typically requires the entry of a user name and password. The software authenticates by using the built-in front facing imaging device such as a camera to obtain a facial recognition template. At about the same time, the user is prompted to enter a gesture that they had previously enrolled. Both the face and gestures are compared to the database of previously enrolled templates of enrolled users. By having both biometric facial data and gesture comparisons at substantially the same time, the matching tolerance for each factor is reduced without reducing the reliability of the security. This allows for a greatly improved user experience as the conditions that normally would lead to a reduction in the confidence of facial recognition or gesture recognition and which would normally cause an undesired false rejection of the real user are greatly reduced.

Those skilled in the art will further recognize that many different variations of gesture and biometric information such as exact/tolerant factors as well as multiple tolerant factors can include but are not limited to:

Exact Factor and Tolerant Factors

Password and Face

Password and Gesture

Password and Pattern

Password and Fingerprint

Pin and Face

Pin and Voice

Multiple Tolerant Factors

Face and Gesture

Face and Partial Password (reduce number of password characters for acceptance)

Face and Pattern

Face and Fingerprint

Face and Voice

Face, Voice and Gesture

Face and Shapes

Shapes and Gesture

According to various embodiments of the invention, instead of using an assigned login name and password, the method as described herein, leverages the unique, individual characteristics of a user's face coupled with a pin, gesture (movement of the user's finger on the touch screen, in a pattern of their choice) or combination displayed symbols, shapes or other indicia to verify identity and to provide secure, convenient access. Not only does this new methodology provide easy access, the embodiments as described herein solve the problem of secure two factor authentication in an easy, fast to enter and non-stressful manner.

Thus, the present invention can also provide a personalized, cloud based password vault, allowing convenient, universal “single sign-on” (login once for many applications and devices). As described herein, a password of many letters, numbers, symbols, shapes or other indicia known and keyed in by the user to gain access. Passwords stored in the vault from any device are instantly available anywhere and on any other device and may be cached on the local device. An advantage of this cloud based storage is that all information is always encrypted until just before the moment it is used. An embodiment of the invention further includes multi-platform support for Windows, iOS, Android and other operating system devices. Moreover, passwords can also be stored centrally in the cloud and are fully encrypted. A further advantage of this arrangement is that the devices (phones, computers, tablets, etc.) can be damaged, lost or rebuilt yet the database will remain accessible to the authorized user. Consequently, aspects of the invention allow many users to share a single mobile device securely and separately from one another. Each user has their own private password memory storage area or “vault” which is only usable via that person's unique face and gesture.

Because a PC has reduced mobility and is often only used in a limited number of locations, these types of conditions allow for a more intolerant setting for recognition matching requirements. In such setting, the PC typically has a very low false positive rate of only about 6.3 in 10⁶ false positives/access attempts. Thus, in a PC environment, after a brief period of learning, good recognition rates are achieved while maintaining high accuracy. However, a typical PC environment is relatively controlled with respect to lighting and views of the face. This is not the case for mobile devices Where lighting and the handheld mobile device's view of the face changes dramatically all the time since a mobile device has a higher variance in lighting and camera angle/distance of the face from the camera. In order to maintain a very high rate of recognition in this varied environment, matching tolerances must be slightly relaxed in order to provide an excellent recognition rate. Unfortunately, relaxing tolerances also increases the potential for incorrect recognitions. Even a casual user will not tolerate a higher false recognition rate and the resulting unauthorized access of their private data.

Using a secondary factor, such as a pattern when the face is being recognized, exponentially increases authentication accuracy so that the input of pattern/pin concurrently with face recognition is extremely fast, natural and convenient. This allows the invention to implement the face recognition match tolerance value which provides excellent recognition in varied lighting and at various face angles while improving overall authentication accuracy beyond that of most authentication solutions. Using both facial recognition with a gesture minimizes the weakness of both. In the case of face recognition, the gesture prevents photo or video attacks, while a face prevents another authorized user from simply observing and repeating the gesture. Hence, a successful “smudge attack” would essentially amount to no access without a face. A successful “replay attack” (photo/video) means no access without also using a gesture. Having multiple factors also helps to minimize social engineering. As with all forms of security/secrecy, having personal knowledge of the user can increase the speed at which unauthorized access is gained. Requiring multiple, independent types of information reduces the likelihood that any individual piece of personal knowledge will be sufficient.

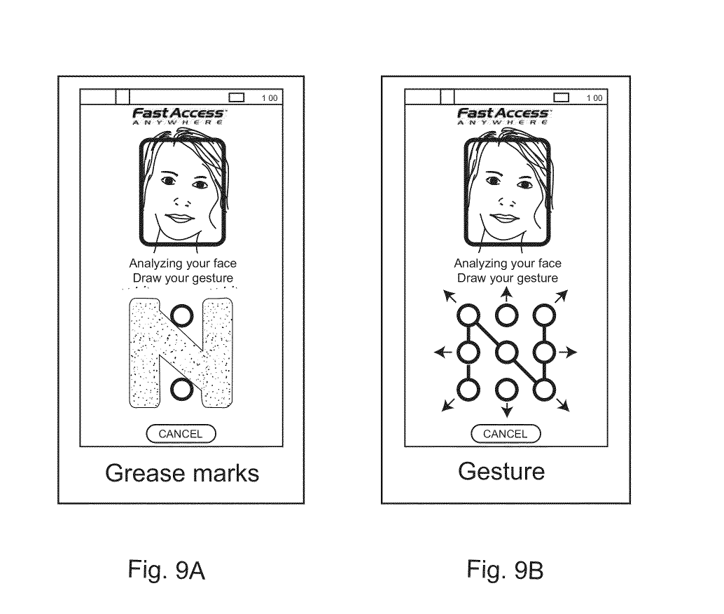

FIGS. 9A and 9B illustrate a touch screen which exhibits the features of dynamic gesture placement. FIG. 9A illustrates the appearance of finger smudges or residue left on the touch screen surface when the drawing area remains in the same or consistent location. Because of this pattern of residue, the residue may allow an unauthorized person to gain insight into a given user's gesture, reducing the security of that factor. FIG. 9B illustrates the use of dynamic gesture placement meaning that when each time a gesture is required, the method of the invention carefully moves the placement of the gesture entry points on the touch screen display. A data entry area on the display can be dynamically moved and/or skewed in any direction on the display such as up, down, to the side or diagonally. This process allows the grease marks to overlap, greatly reducing the likelihood that an authorized person will be able to infer the gesture. This eliminates a common weakness of pattern security where grease streaks from finger oils or other residue on the device's screen can suggest or be displayed as the user's gesture or finger movement pattern.

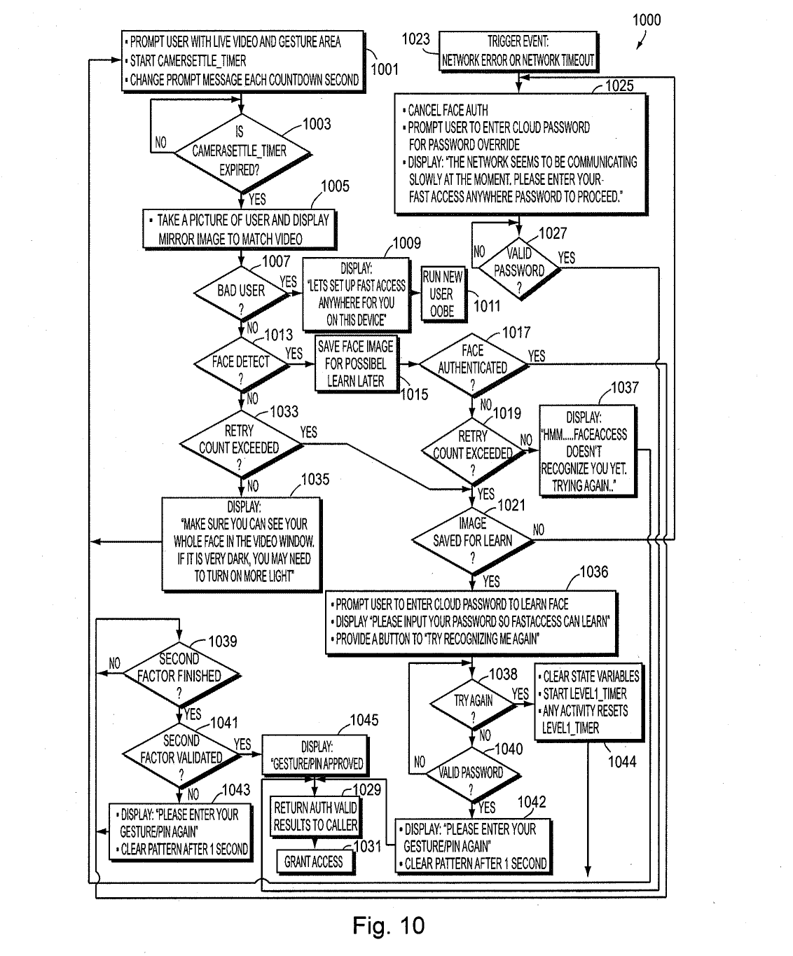

FIG. 10 illustrates a flow chart diagram showing the authentication process used in connection with a non-transitory computer readable medium implemented with various embodiments of the invention. The authentication process 1000 begins where a user is prompted with live video and a message in the data entry or “gesture” area of the touch screen display 1001. A determination is made if a camera settle timer has expired 1003. If not, this process continues until the camera is sufficiently still for a predetermined time period for capturing one or more images. Once the timer has expired, an image of the user is captured and displaced to the user on the touch screen of the electronic device 1005. In addition, a “start scan” animation can be displayed to the user for providing notification of the video authentication capture while other various indicia may also be displayed on the screen. A retry counter is incremented in order to capture a predetermined number of pixels or frames and the image is sent to a predetermined location for evaluation.

Thereafter, a determination is made if the user is invalid, also known as a “bad user” 1007. If the user is invalid or bad 1009, then the display will inform the user that an initial “set up” or programming of the system software is required 1009. In this case, the user is directed to secondary set-up steps 1011. However, if the user is not invalid, then the process determines if the user's face is detected 1013. If detected, the facial image is saved for a later learning step 1015 and a determination is made if the face is authenticated through comparison with data stored locally or in a cloud database 1017. If the face is authenticated, the process moves on to determine if a second factor has been entered 1039. As described herein a “second factor” is a gesture or entry of combination of symbols displayed on the touch display as described herein. However, if the face is not authenticated 1017, the system determines if a retry count has been exceeded 1019. If the retry count is not exceeded, the system informs the user that they are not recognized 1037 and the process begins again by prompting the user 1001.

If the retry count is exceeded 1019, then the system determines if the image has been saved for a later learning step 1035. If the image is saved, then the user is prompted to enter a cloud password that is used for learning the user's face. Thereafter, the user' facial image can be processed and saved 1036. This process will retry 1038 and enter a clearing state 1044, or if a valid password is entered 1040, then the image is saved for a system “learning” step of process 1042. A valid user authentication is determined 1029 so that the user is granted access to the electronic device 1031. If the image is not saved 1035, then this triggers a network error or network timeout message 1023 and the user face authentication processing steps can be cancelled. Thereafter, the user is prompted to enter a password override 1025. Once entered and determined to be a valid password 1027, valid authentication commands can be issued 1029 and the user is granted access to the electronic device 1031.

As noted herein, once facial authentication has occurred 1017, a second determination is made if a second factor has been entered by the user 1039. The second factor may include but is not limited to a screen gesture, password, entry of displayed symbols or various combinations thereof. If the second factor is not validated 1041, the user is prompted to reenter the gesture of pin 1043 and this process begins again 1039. However, once the second factor is validated 1041, an approval or acknowledgment is displayed to the user 1045 and the user authentication credentials are validated such that they are granted access to the electronic device 1031.

Thus, as described in the password override process 1025, the method of the invention provides for a “fallback” access operation so that in the event a “standard” authentication cannot occur (for example if face recognition is not possible due to extreme lighting conditions), a single or multifactor override is possible. The complexity requirements for this override and each factor can be set to meet the desired security goals. Override options include but are not limited to entry of: a personal identification number (PIN); a screen gesture and PIN; a complex password (letters, numbers and/or symbols); or a screen gesture and a complex password.

Storing sensitive information in the cloud can sometimes be a cause for concern therefore careful consideration often is necessary since any unauthorized breach of information can be detrimental to system operation. According to another aspect of the invention, credentials can be encrypted on a cloud server and/or local electronic device using a Rijndael symmetric algorithm with a fixed block size, iteration count, and at least a 128 bit key. This encryption technique often exceeds the standards for government and financial data. Website credentials are encrypted as “data blobs” using an encryption key unique to each user. Thus, in the unlikely event that one user's account is compromised, the key could not be used to access other user's data since no party other than the user will know the encryption key or password. Because this critical information can remain unknown, local backup of the credential database is always recommended. Since password recovery from the cloud is not possible, data is never transmitted in an unencrypted state. Indeed, it never exists in an unencrypted state right up until the time of use. In this configuration, the electronic device (phone, tablet, laptop, etc.) is a simple or “dumb” client on which data is typically not stored locally. This means that even if the device is stolen, passwords are not physically present to be taken no matter the hacking effort expended. Limited time local caching is optionally available so that the invention can allow an administrator to operate off the network when necessary while still minimizing risk.

Thus, the system and method of the invention provide fast, simple, and secure access to a personal computer or other electronic device that requires security. The invention combines the use of a screen gesture with biometric security in the authentication process. By combining at least two factors analyzed at about the same time, the tolerance match required by the tolerant factor(s) can be reduced without reducing the overall security accuracy of the electronic device. This level of accuracy combined with biometric techniques means that the invention uniquely provides fast, accurate logins to devices, websites and apps using secure cloud based credentials available across many platforms and personalized access to devices without user accounts such as Android and iOS. The imaging used in connection with embodiments of the invention is lighting tolerant offering very strong photo and video rejection of unwanted images.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A facial biometric recognition system for providing security for an electronic device comprising:
a digital camera having a field of view for providing a plurality of facial biometric images from a user of the electronic device for establishing a first security factor;
a touch screen for enabling the user to enter data for establishing a second security factor;
at least one processor associated with the electronic device for comparing the first factor and second factor to data stored in a database; and
wherein access to the electronic device is enabled if the first factor and second factor match data stored in the database.

2. A facial biometric recognition system as in claim 1, wherein a data entry area on the touch screen can be dynamically placed for preventing recognition of previously entered data through finger residue.

3. A facial biometric recognition system as in claim 1, wherein the second factor is a screen gesture.

4. A facial biometric recognition system as in claim 1, wherein the second factor is a predetermined combination of displayed symbols.

5. A facial biometric recognition system as in claim 1, wherein the database is within the electronic device.

6. A facial biometric recognition system as in claim 1, wherein the database is a cloud.

7. A facial biometric recognition system as in claim 1, wherein the electronic device is one from the group of personal computer, personal digital assistant, mobile telephone or gaming device.

8. An electronic device using facial biometric security for providing access comprising:
a digital camera for providing first authentication credentials based on at least one user image;
a touch screen for entering second authentication credentials based on user input data;
a memory for storing the first authentication credentials and second authentication credentials;
a microprocessor for comparing the first authentication credentials and second authentication credentials to data stored in a database; and
wherein the user is granted access to the electronic device after the user is authenticated with valid first authentication credentials and second authentication credentials.

9. An electronic device as in claim 8, wherein a data entry area on the touch screen can be dynamically moved for preventing recognition of previously entered data through finger residue.

10. An electronic device as in claim 8, wherein the second authenticating credentials are a screen gesture.

11. An electronic device as in claim 8, wherein the second authentication credentials are a predetermined sequence of symbols selected by the user.

12. An electronic device as in claim 8, wherein the symbols are a plurality of shapes.

13. An electronic device as in claim 8, wherein a data entry area on the touch screen can be moved in order to prevent recognition of finger residue.

14. An electronic device as in claim 8, wherein the database is within the electronic device.

15. An electronic device as in claim 8, wherein the database is in a cloud accessed via the Internet.

16. An electronic device as in claim 8, wherein the electronic device is one from the group of a personal computer (PC), personal digital assistant (PDA), cellular telephone or gaming device.

17. A non-transitory computer readable medium having computer readable instructions stored thereon for execution by a processor in an electronic device to perform a method comprising the steps of:
using a plurality of facial biometric images as a first authentication factor provided from a digital imaging device input into a memory;
dynamically placing a data enter area on a touch screen based upon previous used data enter area positions;
using the touch screen to enter a second authentication factor from the user;
utilizing at least one processor for authenticating the identity of the user using a the first authentication factor and second authentication factor with information stored in a database; and
denying use of the electronic device if no user authentication is made within a predetermined time period.

18. A non-transitory computer readable medium as in claim 17, further comprising the step of:
entering a screen gesture as the second authentication.

19. A non-transitory computer readable medium as in claim 17, further comprising the step of:
entering a sequence of symbols displayed on the touch screen as the second authentication.

20. A non-transitory computer readable medium as in claim 19, further comprising the step of:
displaying a group of shapes as the symbols.

21. A non-transitory computer readable medium as in claim 17, further comprising the step of:
including the database in the electronic device.

22. A non-transitory computer readable medium as in claim 17, further comprising the step of:
including the database in a cloud accessed via the Internet.

23. A non-transitory computer readable medium as in claim 17, wherein the electric device is one from the group of: personal computer (PC), personal digital assistant (PDA), cellular telephone or gaming device a mobile telephone.

24. A method for providing security to an electronic device comprising the steps of:
displaying an authentication screen;
providing data from at least one camera for providing biometric authentication data;
providing user input data to a touch screen display;
comparing the biometric authentication data to information stored in a database;
comparing the user input data to information stored in a database;
determining if the user is authenticated;
inputting authentication credentials into an application run on the electronic device if the user is authenticated; and
granting access to the electronic device.

25. A method for providing security as in claim 24, further comprising the step of:
using the user's face as the biometric authentication data.

26. A method for providing security as in claim 24, further comprising the step of:
using a screen gesture as the user input data.

27. A method for providing security as in claim 24, further comprising the step of:
using a predetermined sequence of symbols displayed on the touch screen display.

28. A method for providing security as in claim 27, further comprising the step of:
displaying a plurality of shapes as the symbols on the touch screen display.

29. A method for providing security as in claim 24, further comprising the step of:
moving a data entry area displayed on the touch screen display for preventing recognition of previously entered data though residue left on the touch screen display.

30. A method for providing security as in claim 24, further comprising the step of:
providing a tolerant factor by selecting either of the biometric authentication data or the user input for granting access to the electronic device if the comparison is within a predetermined tolerance.

31. A method for providing security as in claim 24, further comprising the step of:
including the database in the electronic device.

32. A method for providing security as in claim 24, further comprising the step of:
including the database in a cloud accessed via the Internet.

33. A method for providing security as in claim 24, wherein the electric device is one from the group of: personal computer (PC), personal digital assistant (PDA), cellular telephone or gaming device a mobile telephone.
